(19) United States
(12) Patent Application Publication
(10) Pub. No.: US 2012/0109884 A1
(43) Pub. Date: May 3, 2012

(54) ENHANCEMENT OF USER CREATED DOCUMENTS WITH SEARCH RESULTS

(75) Inventor: Lev Goldentouch, Rishon Lezion (IL)

(73) Assignee: PORTOOL LTD., Rishon Lezion (IL)

(21) Appl. No.: 13/282,499

(22) Filed: Oct. 27, 2011

Related U.S. Application Data
(60) Provisional application No. 61/407,030, filed on Oct. 27, 2010.

(51) Int. Cl. G06F 17/30

(52) U.S. Cl. 707/608; 707/E17.005

(57) ABSTRACT

A non-transitory computer readable medium and a method for enhancing a document with search results, the method may include: displaying to a user, within a first screen of a split-screen interface, at least a portion of a document while displaying, within a second screen of the split-screen interface, at least one search result obtained from searching information sources that differ from the document; receiving a request from a user to copy at least a portion of at least one search result to the document; incorporating the portion of the at least one search result to the at least portion of the document thereby providing an amended document; receiving from the user a request to edit the amended document; and editing the amended document in response to the request.

### RELATED APPLICATIONS

This patent applications claims priority from U.S. provisional patent 61/407,030 filing date Oct. 27 2010, which is incorporated herein by reference.

### FIELD OF THE INVENTION

The present disclosure relates generally to content creation, and more specifically, to the enhancement of user created documents with search results, creating a document such as a review, report, essay, analysis or argument, for example.

### BACKGROUND OF THE INVENTION

Users frequently use online sources to create and exchange information. Email, instant messaging (IM), message boards, websites, and blogs are all existing communication technologies through which users can create and distribute content to other users. Web-based document editors, such as Google Docs™ or Etherpad™, enable easy online editing of content and real-time collaboration over online content. Bibliography web sites, such as EasyBib™ and BibMe™ enable automatic and manual creation and management of the bibliography.

Frequently, in creating document, a user may wish to incorporate online information sources. For example, a user may use web search to find a web page of interest, a browser to navigate to a web page that the user would like to reference in the document, copy the link and the some parts of the content of the referenced page from the browser to a “clipboard,” and then paste the data from the clipboard into the document. In this manner, the user can create a document incorporating online information sources.

An alternative technique of document creation incorporating online information sources involves bookmark collection tools such as Clipmarks™ and Evernote™. The user may collect the web pages of interest into a bookmark collection tool and copy export the bookmark collection into a document editor.

Search engines are a popular tool through which users enter a search query describing information of interest and receive back documents or links to documents that relate to the search query. Frequently, when “researching” content the user may perform one or more searches using one or more search engines to locate online documents relevant to the content. The user may then copy links and parts of found web pages into the document using the above-described methods of copying and pasting to the document. This process for user created content can be tedious, difficult to perform for average users, and often results in broken links and ill-formatted HTML text in the final content that can be difficult to read.

Accordingly, it would be desirable to improve the above-described content creation process.

### SUMMARY OF THE INVENTION

A method for enhancing a document with search results, the method may include: displaying to a user, within a first screen of a split-screen interface, at least a portion of a document while displaying, within a second screen of the split-screen interface, at least one search result obtained from searching information sources that differ from the document; receiving a request from a user to copy at least a portion of at least one search result to the document; incorporating the portion of the at least one search result to the at least portion of the document thereby providing an amended document; receiving from the user a request to edit the amended document; and editing the amended document in response to the request.

The method may include receiving at least one search query from the user; and generating the at least one search result.

The method may include generating a search query and generating the at least one search result.

The method may include generating the search query by applying semantic keyword extraction processing.

The method may include generating the search query by applying document category detection that is followed by a document category related semantic keyword extraction processing.

The searching of information sources is conducted by a system; and the information sources may include at least one information source out of a database that is stored at the system, a database that is stored at a website that is affiliated with the system and the internet.

The method may include allowing the user to graphically select the at least portion of at least one search result, and placing the portion of the at least one search result at a location pointed by the user.

The method may include performing an additional processing operation based on the least portion of the at least one search result; and displaying to the user a result of the additional processing.

The additional processing operation may include generating bibliographic information and displaying the bibliographic information at the first screed of the split-screen interface.

The method may include receiving from the user to distribute the amended document to at least one other user; and participating in the distributing of the document to the at least one other user.

The method may include receiving a request from another user to edit the amended document; and editing the amended document in response to the request from the other user.

At least one information sources may include search results conducted by another user.

The information sources may include information sources of multiple types; the method may include displaying of search results obtained from different types of information sources at different windows within the second screen of the split-screen interface.

The information sources of different types may include at least two of the following: a database that is stored at a system that generates the search results, a database that is stored at a website that is affiliated with the system and the internet.

The method may include displaying to the user search result filters and allowing the user to select between the search result filters.

The method may include displaying navigation items that allow the user to navigate between search results.

The method may include displaying status indicative items that indicate a status of search results.

The status may include at least one of viewed status (whether a search result was viewed by the user and copied to the document status.

The status may include at least one of relevant status, irrelevant status, prioritized status and non-prioritized status.

The method may include activating a third party extension that is applied on the amended document.

The method may include applying a least one operation on the document: spelling correction, plagiarism detection, writing style improvement, uniform usage of synonyms, translation, illustration insertion, writing suggestions, content rewriting and contextual advertisement insertion.

The method may include generating the document based on the at least one search result.

The method may include ranking paragraphs of the search results and generating the document by selecting a predetermined number of highest ranking paragraphs of the search results.

The ranking of the paragraphs is responsive to location of the paragraphs within the search results.

The method may include processing the at least portion of the at least one search result before the incorporating into the document.

A non-transitory computer readable medium may be provided and may store instructions for: displaying to a user, within a first screen of a split-screen interface, at least a portion of a document while displaying, within a second screen of the split-screen interface, at least one search result obtained from searching information sources that differ from the document; receiving a request from a user to copy at least a portion of at least one search result to the document; incorporating the portion of the at least one search result to the at least portion of the document thereby providing an amended document; receiving from the user a request to edit the amended document; and editing the amended document in response to the request.

The non-transitory computer readable medium may store instructions for receiving at least one search query from the user; and generating the at least one search result.

The non-transitory computer readable medium may store instructions generating a search query and generating the at least one search result.

The non-transitory computer readable medium may store instructions generating the search query by applying semantic keyword extraction processing.

The non-transitory computer readable medium may store instructions for generating the search query by applying document category detection that is followed by a document category related semantic keyword extraction processing.

The instructions stored in the non-transitory computer readable medium may be are executed by a system and the information sources may include at least one information source out of a database that is stored at the system, a database that is stored at a website that is affiliated with the system and the internet.

The non-transitory computer readable medium to claim may store instructions for allowing the user to graphically select the at least portion of at least one search result, and placing the portion of the at least one search result at a location pointed by the user.

The non-transitory computer readable medium may store instructions performing an additional processing operation based on the least portion of the at least one search result; and displaying to the user a result of the additional processing.

The additional processing operation may include generating bibliographic information and displaying the bibliographic information at the first screed of the split-screen interface.

The non-transitory computer readable medium may store instructions receiving from the user to distribute the amended document to at least one other user; and participating in the distributing of the document to the at least one other user.

The non-transitory computer readable medium may store instructions receiving a request from another user to edit the amended document; and editing the amended document in response to the request from the other user.

At least one information sources may include search results conducted by another user.

The information sources may include information sources of multiple types; the non-transitory computer readable medium may store instructions for displaying of search results obtained from different types of information sources at different windows within the second screen of the split-screen interface.

The information source of different types may include at least two of the following: a database that is stored at a system that generates the search results, a database that is stored at a website that is affiliated with the system and the internet.

The non-transitory computer readable medium may store instructions displaying to the user search result filters and allowing the user to select between the search result filters.

The non-transitory computer readable medium may store instructions displaying navigation items that allow the user to navigate between search results.

The non-transitory computer readable medium may store instructions displaying status indicative items that indicate a status of search results.

The status may include at least one of viewed status and copied to the document status.

The status may include at least one of relevant status, irrelevant status, prioritized status and non-prioritized status.

The non-transitory computer readable medium may store instructions activating a third party extension that is applied on the amended document.

The non-transitory computer readable medium may store instructions applying a least one operation on the document: spelling correction, plagiarism detection, writing style improvement, uniform usage of synonyms, translation, illustration insertion, writing suggestions, content rewriting and contextual advertisement insertion.

The non-transitory computer readable medium may store instructions generating the document based on the at least one search result.

The non-transitory computer readable medium may store instructions ranking paragraphs of the search results and generating the document by selecting a predetermined number of highest ranking paragraphs of the search results.

The Ranking of the paragraphs is responsive to location of the paragraphs within the search results.

The non-transitory computer readable medium may store instructions processing the at least portion of the at least one search result before the incorporating into the document.

### BRIEF DESCRIPTION OF THE DRAWINGS

The present invention will be readily understood by the following detailed description in conjunction with the accompanying drawings, wherein like reference numerals designate like structural elements.

FIG. 1 illustrates a method for generation of user created documents with search results according to an embodiment of the invention.

FIG. 2 illustrates a system for enhancement of user created documents with search results according to an embodiment of the invention.

FIG. 3 illustrates a user interface for enhancement of user created documents with search results according to an embodiment of the invention.

FIG. 4 illustrates an export window for user interface for enhancement of user created documents with search results according to an embodiment of the invention.

FIG. 5 illustrates a method for enhancement of user created documents with search results according to an embodiment of the invention.

FIG. 6 illustrates a method for “search and edit” process for enhancement of user created documents with search results according to an embodiment of the invention.

### DETAILED DESCRIPTION OF THE DRAWINGS.

The following figures illustrate exemplary embodiments of the invention. They are not intended to limit the scope of the invention but rather assist in understanding some of the embodiments of the invention. It is further noted that all the figures are out of scale.

A system for enhancement of user created documents with search results comprising user client software for presenting the search results and performing editing of the document; wherein a user may transfer a search result into the document being edited; server front-end software for aggregation and personalization of interfaces; pad management software for real-time management of the document being edited; search results objects indexing software for extraction of meaningful paragraphs from search results. The system further comprising search engine management software, marketplace management software and affiliate management software.

A document creation application comprising a first screen for navigating through meaningful objects from search results, a second screen for editing of the user-created documents enhanced by search results; a code for drag-and-drop for the first screen to the second screen. The application, further comprising a code for automatic bibliography creation from the content transferred between the first screen and the second screen. The application, further comprising real-time editing of the user created document. The application, further comprising export to at least one of (a) version control system, (b) file on local device, (c) document marketplace.

A method for document creation from search results comprising user entering a search query; in response to user query server generating search results meaningful paragraphs; the user navigating the meaningful paragraphs; the user finding a paragraph of choice; the user transferring the paragraph of choice into an editor interface; the server creating bibliography entry in response to user selecting a paragraph of choice; the bibliography entry added to the document in the editor interface; the user exporting document from the editor interface. The method further comprising second user collaborating in real-time with the first user on the same document. The method further comprising sharing queries and search history between the first user and the second user. The method further comprising saving or sharing document created from search results.

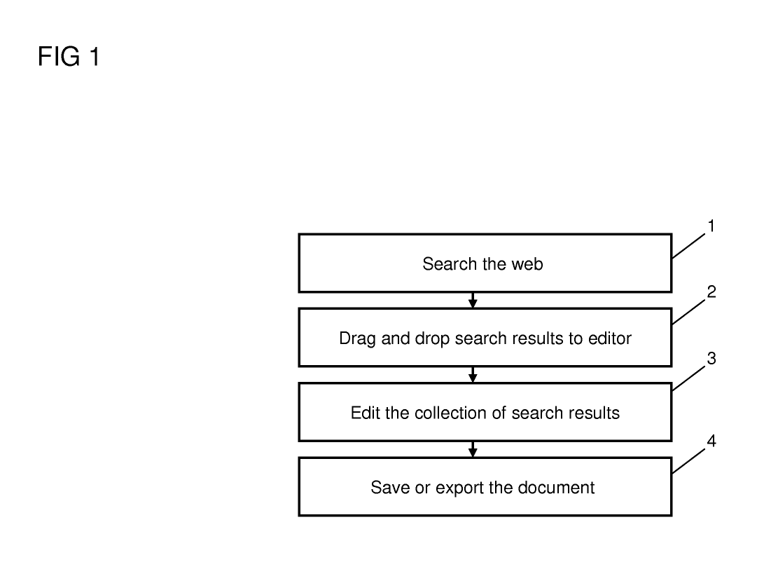

FIG. 1 illustrates a method for generation of user created documents with search results according to an embodiment of the invention.

A user searches the web 1 using a search interface. The search may be performed on specific URLs or collection of URL, the search may aggregate results of multiple search engines, the search may be performed on a database file or via secure interfaces. The user drags and drops found search results 2 into an editing interface using drag-and-drop or copy-and-paste interface. “Drag and drop” may be implemented via HTML5 drag and drop features, using Yahoo YUI™ drag and drop interface, via iPhone™ drag and drop, using copy and paste within user's device, using copying scripts or via any other suitable dragging and dropping or copying and pasting method. The user may further edit 3 the collection of search results previously copied into the editing interface. The editing step may include all suitable operations of rich text, table or presentation editing and formatting, manipulations with bibliography and search results URLs, collaboration between multiple users or any other suitable editing. The user may further save or export the generated document 4 via the document's save and export interface. The document's save and export interface may enable conversion of multiple document representation formats, may enable download to user's device or any other device specified by the user, may supports upload to various marketplace and sharing sites, may support encryption, may support version control and document syncing or any other suitable save and export operation.

The graphical interfaces and user input at search and edit processing is optional. In some embodiment either search, or edit or both parts may be performed by a computational device using natural language processing, statistical algorithms or other suitable processing method.

In some embodiments the search results, editing window parameters, advanced search options, search-related advertising, editing functionality, and any other suitable functionality may be adapted to the specific device hold by specific user at any particular time. The specific device adaptation may change dynamically based on device properties, including time, country, motion, network connection, sensor input, voice or video input or any other suitable signal. The specific device adaptation may include adaptation to the screen size of the specific device, the spatial orientation of the specific device, language, geographical location of the device, access to various networks (including enterprise intranet, university network, internet café network, secure military network, banking network or any other suitable network), proximity to predefine sites, proximity to another user or any other suitable spatial parameter.

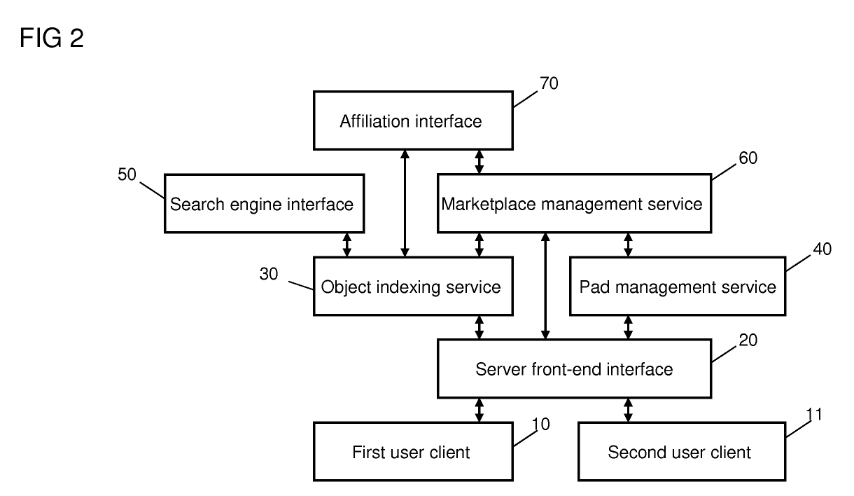

FIG. 2 illustrates a system for enhancement of user created documents with search results according to an embodiment of the invention.

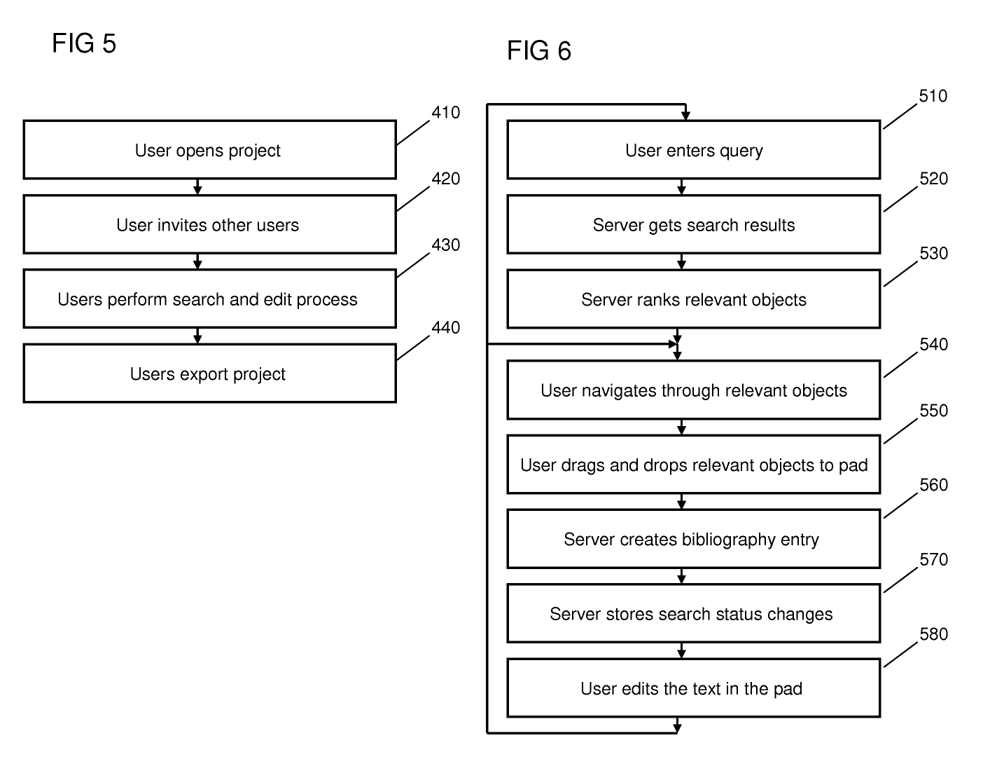

The first user client 10 and the second user client 11 enable multiple users to perform “search and edit” operations as illustrated on FIG. 6. The client interface may vary based on user preferences, authorization to view, edit and moderate various documents, and status. The operations performed by the first user may influence the display of the second user and vice versa, for example if the users chat, or collaborate on the document content. The server front-end interface 20 aggregates and personalizes the content for display to the first and the second users. In some embodiments, the server front-end interface 20 may be implemented as a content management system, such as Drupal™ or Joomla™, and various back-end services may be implemented as modules and components. In some embodiments, the server front-end interface 20 may generate and manage bibliography, search results history or other suitable metadata.

In some embodiments, the search query may be generated based on voice input command from the user via speech to text engine or any other suitable mechanism.

In some embodiments, the search query is generated based on video input based on barcode recognition, object recognition, optical character recognition, face recognition or any other suitable method.

In some embodiments the displayed search results may overlay some other image, including image coming from the user's camera, web site, video player or any other suitable video source.

The object indexing service 30 extracts meaningful paragraphs from search results to be used for content being edited. In some embodiments, the object indexing service is implemented as described by Goldentouch in U.S. patent application Ser. No. 12/573,339. In some embodiments the object indexing service may receive the search results from the web search engines, such as Google™ or Bing™, using search engine interface 50. In some embodiments the search engine interface 50 may execute queries using multiple search engines and interleave search results from various search engines.

In some embodiments the search may be performed over unstructured data, such as hard disk image or any other unstructured digital content. In some embodiments the meaningful paragraph may refer to structured text, unstructured text, binary data limited by some binary markers, image data limited by some spatial markers, video or voice data limited by some temporal markers, a combination of thereof or some other digital information limited by some detectable markers.

In some embodiments the object indexing service may receive the search results from affiliate document management services, such as Amazon™ or Scribd™, using affiliation interface 70. In some embodiments, web crawler such as Apache Nutch™ or IBM Omnifind™ may be used for affiliation engine, effectively indexing the affiliate sites. In some embodiments, the affiliate documents may be routed from various RSS feeds and news pipes using aggregator services, such as Yahoo Pipes™

In some embodiments, the affiliate documents may be detected via e-discovery software, web sniffer or any other digital monitoring equipment.

In some embodiments the indexing service may receive the search results from the internal search engine of the invention using documents previously stored by the users on marketplace management service 60. For example Apache Lucene™ or IBM Omnifind™ may provide indexing mechanism for internal search engine. In some embodiments, the results of document indexing may be used for generation of metadata and title for web pages and further used for search engine optimization. In some embodiments, the documents may be automatically classified to document categories using a feature-based classifier such as Apache Mahout™. In some embodiments, the classified documents added by users may be broadcasted via social media, such as Facebook™ or Tweeter™.

The pad management service 40 enables editing of the content document, and it may be implemented by one of the on-line document editing systems, such as Etherpad™, CKEdit™ or Google Docs™. In some embodiments, the users may collaborate in real-time using so called “comet” AJAX communication interfaces supported by some of the on-line document editing systems. In some embodiments the pad management service 40 may also have version control functions. In some embodiments, multiple users may collaborate on common documents, invite specific editing services from other users, share search history, perform document-related chat or conferencing or perform other collaboration-related activities.

The pad management service 40 may be configured to perform import and export of the pad documents to a marketplace management service 60. The documents managed by the marketplace management service 60 may be shared, sold and bought by various users, such as first user and second user via server front-end interface 20. In some embodiments the marketplace management service 60 may also have analytics, authentication and billing functions for the users, such as the first user and the second user. In some embodiments the marketplace management service 60 may further trade documents with affiliate web sites using the affiliation interface 70. In some embodiments, the affiliation interface 70 may provide an abstraction layer for indexing and accessing documents on the multiple affiliate sites, and may include authorization, billing and analytics functions for the affiliates.

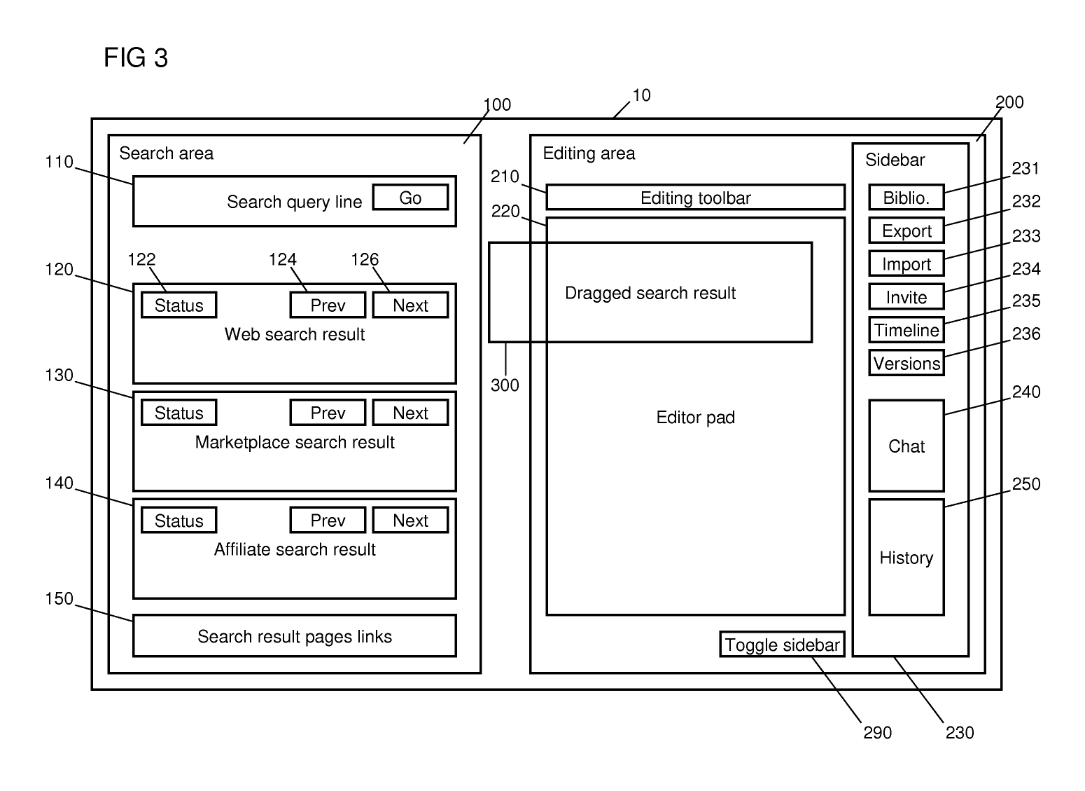

FIG. 3 illustrates a user interface for enhancement of user created documents with search results according to an embodiment of the invention.

The first user client 10 may be implemented as a split-screen user interface where the first part of the screen is a search area 100 and the second part of the screen is an edit area 200. The user may drag and drop the relevant search result objects from the search area 100 to edit area 200, such as dragged search result 300.

The search area 100 may include a search query line 110, where the first user may write search query, may choose search preferences and search result filters, may receive search suggestions based on search history of the first user and suggestions available via the search engine interface 50, and may execute the search query. The search results may be formed from collection of search results from various sources, including web search result 120, marketplace search result 130 and affiliate search result 140. In some embodiments, within each search result, the user may navigate between meaningful objects using previous object button 124 and next object button 126. In some embodiments, within each search result, the user may see the search result status relevant for the search result data-source in status indicator 122. In some embodiments the status indicator 122 may modified in response to the user (a) navigating between relevant objects per search result, (b) dragging and dropping search results into the editing area 220, (c) marking a search result as irrelevant or otherwise modifying search result priority or performing any other activity effecting search result status. The user may navigate between multiple pages of search results using search result pages links 150.

In some embodiments, the search query may be formed without user's input automatically by a computational device via semantic keyword extraction processing using statistical algorithms or natural language processing. The keywords may be extracted from stored document or documents, links to documents on some depository, user profile of the user executing the query, template of the document the user is trying to create or any other suitable source.

Is some embodiments, document category detection may performed prior to keyword extraction, so that the extracted keywords are specific to some document category. The document category may include scientific discipline (such as math, economics, history), document type (research report, business plan, legal document), language (English, French, Spanish), document source (Google, Facebook, enterprise network) or any other suitable document category. In some embodiments the document category may be computed using the document structure and keyword, including document name, document metadata, names of the sections within the document, keywords within the document text or any other suitable criteria.

The editing area 210 contains a main editing area and a sidebar. The main editing area contains the editing toolbar 210, editor pad 220 and toggle sidebar button 290. The editor toolbar 210 enables standard editing operations, such as font size and style selection, bullets and numbering, paragraph styles, insert objects, spelling, equation editor, tables or any other suitable editing operation supported by editors such as Google Docs™ and MSOffice™. The editor pad 220 displays the document being edited in format selected by the user, so that the user may edit the document in real time using caret position indication. In edition to standard editing operations as enabled by toolbar 210, the editor pad may support dreg and drop of search results from the search area 100, automatic bibliography creation and management, authoring styles and colors for multiple collaborating authors and specific editing functions enabled by the sidebar 230. The sidebar 230 may be shown or hidden via the toggle sidebar button 290.

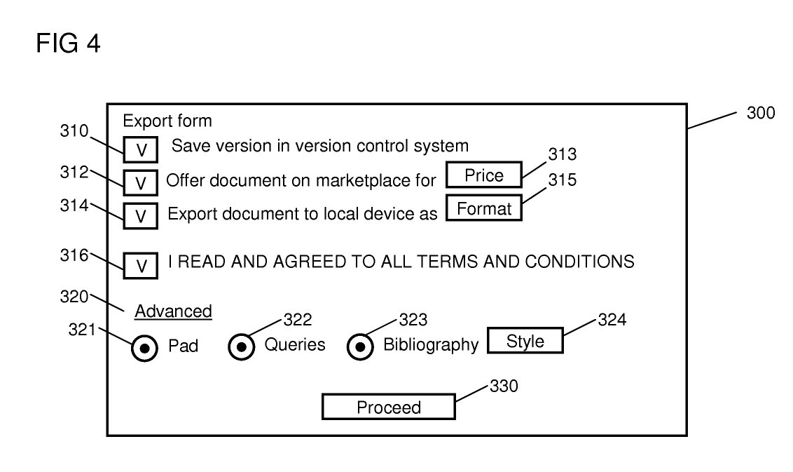

The sidebar 230 may include multiple buttons 231-236, chat area 240 and history area 250. The bibliography button 231 opens bibliography interface, where the user may choose the display style of the bibliography such as MLA, APA, and Chicago/Turabian; the user may also select to display or to hide bibliography in editing and in export stages; the user may insert citation from a source that is not a search result; the user may import bibliography from other document and bibliography repositories; the user may export bibliography. The export button 232 opens export options screen, further discussed on FIG. 4, that enable export, download and save of the generated content. The import button 233 opens import options screen that enables import and copying data from a document stored on local device of the first user, import from a web site specified by URL, import from another document available via the marketplace management service 60 or any other suitable import source. The invite button 234 allows the first user to invite the second user to collaborate on the document. In some embodiments the invitation may be sent via the internal messaging system of the server front-end interface 20. In some embodiments the invitation may be sent via email, SMS, social network invitation or any other suitable communication method. In some embodiments multiple users may collaboratively edit a document in real time, for example the first user performing search and dragging-and-dropping search results, and the second user editing the text. The timeline button 235 displays the creation of the document from the search results progressively in time, similar to the timeline button in Etherpad™ and in Google Wave™. The versions button 236 enables version management of the document. The user may choose to revisit some version of the document, modify it differently from some other versions of the document, merge multiple versions of the version tree and execute other suitable version tree operations. The chat area 240 supports chat between multiple users, such as the first and the second user. The history area 250 supports chat between multiple users, such as the first and the second user. The queries and drag-and-drop operations executed by the collaborating users may appear in the history area. In some embodiments, the history functionality may be merged into the chat area, so that a query or drag-and-drop automatically generates a chat text line.

In some embodiments, the editor may enable activation of additional or third party extensions, including spelling correction, plagiarism detection, writing style improvement, uniform usage of synonyms, translation, illustration insertion, writing suggestions, content rewriting, contextual advertisement insertion or any other suitable extension.

In some embodiments, the document to be edited may be created automatically, by combining highest ranking paragraphs from the search. In some embodiments, the highest ranking paragraphs may be selected based on keywords, text length and other suitable parameters. In some embodiments, the highest ranking paragraphs may be combined according to categorization of document section in which the paragraphs appeared. In some embodiments, relevant bibliography entry may be created automatically per each inserted paragraph. In some embodiments the paragraphs inserted into the document may be automatically rewritten using natural language processing algorithms. In some embodiment the resulting automatically generated document may represent a summary of the multitude of documents provided by the search process.

FIG. 4 illustrates an export window for user interface for enhancement of user created documents with search results according to an embodiment of the invention.

On export form 300 the first user may select several simultaneous ways to save and export document. When the first user selects to save the document in the version system 310, the current version of the document and its metadata are attached a revision number. When a document version is saved, the user may repeat the export operation of the document version any time using version management button 236. When the first user selects to offer a document on the marketplace 312, the price 313 may be set by default. The user may modify the price 313. When the price is set to 0, the document is shared for free. The documents on the marketplace may be also marketed via affiliate channels through the affiliation interface 70. The file format of the document available on the marketplace may be determined by the marketplace properties, including support of multiple file formats simultaneously and transcoding on-demand to some file format. In some embodiments cache may be used to minimize the number of transcoding operations. In some embodiments compression software such as Zip™ may be used to store the transcoded documents. When the first user selects to export the document to the local device 314, he may specify the file format 315, such as PDF™ or MsWord™. The document is then transcoded by the server from the editor database and internal editor format to the target file format, for example using OpenOffice™ transcoding capabilities. In some embodiments, the document may be further transcoded specifically to the specifications of the target device. In some embodiments the user may choose to download the documents in encrypted format. In some embodiments the user may send the exported revision of the document to a third-party service. The user may need to agree to the site's terms and conditions 316 before the export may take place. In some embodiments, plagiarism and copyright checks may be automatically performed and may require additional user interaction. The user may hide or display advanced options 320, such as toggling export to pad text 321, export to search queries and drag-and-drop history 322, and export to bibliography 323 in style 324 selected by the first user. The export process begins when the user chooses to proceed via button 330.

FIG. 5 illustrates a method for enhancement of user created documents with search results according to an embodiment of the invention.

The documents, document history, metadata and other suitable information may be stored as a project. The first user opens a project 410, triggering loading of the information. If several users open the same project, they may collaborate on the project. The first user may be exposed to the second user's project via invite from the second user, by getting the second user's project from the marketplace or by other suitable operation. The first user may choose to load a specific revision of the project, maintained by version management. The first user may choose to load a new project. The name of the project may be used as a default query for the search query line 110. The first user may invite other users, such as the second user, to collaborate on the project 420. The first user may be notified when the second user opens the project he is invited to. The users may perform “search and edit” process 430 further described on FIG. 6 collaboratively. The users may export the project 440 as described on FIG. 4. In some embodiments, some export options, such as export to marketplace 312, are available only to the owner of the project.

FIG. 6 illustrates a method for “search and edit” process for enhancement of user created documents with search results according to an embodiment of the invention.

The “search and edit” process 430 may involve iterative execution of the steps 510-580. The first user enters a query 510. The query selection may be guided by the results of previous search or by suggestion system. If the first and the second users are collaborating on the same project, the query selection may be also guided by (a) advice from the second user, (b) by the results of the previous search executed by the second user, (c) voting results from several users or by any other suitable criteria. The server gets search results 520 from multiple sources, including the web search engines, the affiliate network and the marketplace. The server ranks the objects relevant to the search query 530 to enable navigation between objects using buttons 124 and 126 and status display 122. User navigates through relevant objects 540 until the user sees an object of interest. User drags and drops relevant objects to editor pad 550 for further editing. Server creates bibliography entry based on the URL of the object that has been dragged and dropped. Server stores search status changes 560, including the objects navigated through by the user, the objects dragged and dropped to the editor pad, queries executed or other suitable information. In some embodiments new entry lines may appear in the chat area 240 or history area 250. User edits the text in the pad 570. In some embodiments the dragged-and-dropped search results may appear at the last caret position, enabling fast integration with the text of the document. In some embodiments, new bibliographic entry may appear at the bottom of the text, enabling automatic bibliography management. In some embodiments the collaborating users may edit the newly added search entry to fit the style of the document, while preserving the original text of the search entry as hidden comment for future references. The users may choose to add more search results or perform additional queries, until the document is ready to be exported.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

It is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense

Unless stated otherwise, terms such as “first” and “second” are used to arbitrarily distinguish between the elements such terms describe. Thus, these terms are not necessarily intended to indicate temporal or other prioritization of such elements.

We claim:

1. A method for enhancing a document with search results, the method comprises:
displaying to a user, within a first screen of a split-screen interface, at least a portion of a document while displaying, within a second screen of the split-screen interface, at least one search result obtained from searching information sources that differ from the document;
receiving a request from a user to copy at least a portion of at least one search result to the document;
incorporating the portion of the at least one search result to the at least portion of the document thereby providing an amended document;
receiving from the user a request to edit the amended document; and
editing the amended document in response to the request.

2. The method according to claim 1, comprising receiving at least one search query from the user; and generating the at least one search result.

3. The method according to claim 1, comprising generating a search query and generating the at least one search result.

4. The method according to claim 3, comprising generating the search query by applying semantic keyword extraction processing.

5. The method according to claim 3, comprising generating the search query by applying document category detection that is followed by a document category related semantic keyword extraction processing.

6. The method according to claim 1, wherein the searching of information sources is conducted by a system; and
wherein the information sources comprise at least one information source out of a database that is stored at the system, a database that is stored at a website that is affiliated with the system and the internet.

7. The method according to claim 1, comprising allowing the user to graphically select the at least portion of at least one search result, and placing the portion of the at least one search result at a location pointed by the user.

8. The method according to claim 1, comprising performing an additional processing operation based on the least portion of the at least one search result; and displaying to the user a result of the additional processing.

9. The method according to claim 8, wherein the additional processing operation comprises generating bibliographic information and displaying the bibliographic information at the first screed of the split-screen interface.

10. The method according to claim 1, comprising receiving from the user to distribute the amended document to at least one other user; and participating in the distributing of the document to the at least one other user.

11. The method according to claim 1, comprising receiving a request from another user to edit the amended document; and editing the amended document in response to the request from the other user.

12. The method according to claim 1, wherein at least one information sources comprise search results conducted by another user.

13. The method according to claim 1, wherein the information sources comprise information sources of multiple types; wherein the method comprises displaying of search results obtained from different types of information sources at different windows within the second screen of the split-screen interface.

14. The method according to claim 13, wherein the information source of different types comprise at least two of the following: a database that is stored at a system that generates the search results, a database that is stored at a website that is affiliated with the system and the internet.

15. The method according to claim 1, comprising displaying to the user search result filters and allowing the user to select between the search result filters.

16. The method according to claim 1, comprising displaying navigation items that allow the user to navigate between search results.

17. The method according to claim 1, comprising displaying status indicative items that indicate a status of search results.

18. The method according to claim 17 wherein the status comprises at least one of viewed status and copied to the document status.

19. The method according to claim 17 wherein the status comprises at least one of relevant status, irrelevant status, prioritized status and non-prioritized status.

20. The method according to claim 1, comprising activating a third party extension that is applied on the amended document.

21. The method according to claim 1, comprising applying a least one operation on the document: spelling correction, plagiarism detection, writing style improvement, uniform usage of synonyms, translation, illustration insertion, writing suggestions, content rewriting and contextual advertisement insertion.

22. A non-transitory computer readable medium that stores instructions for:
displaying to a user, within a first screen of a split-screen interface, at least a portion of a document while displaying, within a second screen of the split-screen interface, at least one search result obtained from searching information sources that differ from the document;
receiving a request from a user to copy at least a portion of at least one search result to the document;
incorporating the portion of the at least one search result to the at least portion of the document thereby providing an amended document;
receiving from the user a request to edit the amended document; and
editing the amended document in response to the request.

23. The non-transitory computer readable medium according to claim 22, storing instructions for generating the document based on the at least one search result.

24. The non-transitory computer readable medium according to claim 22, storing instructions for ranking paragraphs of the search results and generating the document by selecting a predetermined number of highest ranking paragraphs of the search results.

25. The non-transitory computer readable medium according to claim 24, wherein the ranking of the paragraphs is responsive to location of the paragraphs within the search results.
